(19) United States
(12) Patent Application Publication
(10) Pub. No.: US 2008/0225969 A1
(43) Pub. Date: Sep. 18, 2008

(54) METHOD AND APPARATUS FOR ADAPTIVE PN LENGTH FOR TDS-OFDM IN TRANSMISSION

(75) Inventors: LIN YANG, Fremont, CA (US); Qin Liu, Fremont, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/048,322

(22) Filed: Mar. 14, 2008

Related U.S. Application Data
(60) Provisional application No. 60/895,135, filed on Mar. 15, 2007.

(51) Int. Cl. H04K 1/10

(52) U.S. Cl. 375/260

(57) ABSTRACT

In a TDS-OFDM system, a method for transmission is provided. The method comprises the step of: adjusting a PN sequence length, whereby a required performance is maintained. The adjusting step comprises increasing, decreasing, or keep unchanging the PN sequence length.

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-034.

U.S. patent application Ser. No. ______ with attorney docket number LSFFT-035.

U.S. patent application Ser. No. ______ with attorney docket number LSFFT-036.

U.S. patent application Ser. No. ______ with attorney docket number LSFFT-037.

U.S. patent application Ser. No. ______ with attorney docket number LSFFT-039.

U.S. patent application Ser. No. ______ with attorney docket number LSFFT-040.

U.S. patent application Ser. No. ______ with attorney docket number LSFFT-041.

### REFERENCE TO RELATED APPLICATIONS

This application claims an invention which was disclosed in Provisional Application No. 60895135, filed 15 Mar. 2007 entitled “METHOD AND APPARATUS FOR ADAPTIVE PN LENGTH FOR TDS-OFDM IN TRANSMISSION”. The benefit under 35 USC §119(e) of the U.S. provisional application is hereby claimed, and the aforementioned application is hereby incorporated herein by reference.

### FIELD OF THE INVENTION

The present invention relates generally to application to TDS-OFDM system, more specifically the present invention relates to adaptive PN length for TDS-OFDM system in information transmission.

### BACKGROUND

TDS-OFDM is successfully applied to digital TV application such as DMB-TH. However, duo to channel variation, TDS-OFDM system needs adaptation to channel conditions to maintain reliability and high performance. The length of PN sequence affects the performance to the applications of using PN sequence, such as channel estimation and synchronization. Coding schemes also affect the communication reliability and performance.

Therefore, there is a need for a TDS-OFDM system in information transmission having adaptive PN length.

### SUMMARY OF THE INVENTION

In a TDS-OFDM system, variable PN length is provided.

In a TDS-OFDM system, a method for transmission is provided. The method comprises the step of:adjusting a PN sequence length, whereby a required performance is maintained. The adjusting step comprises increasing, decreasing, or keep unchanging the PN sequence length.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of an OFDM system in accordance with some embodiments of the invention.

FIG. 2 is an example OFDM symbol in accordance with some embodiments of the invention.

FIG. 3 is an example of down link in accordance with some embodiments of the invention.

FIG. 4 is an example up link in accordance with some embodiments of the invention.

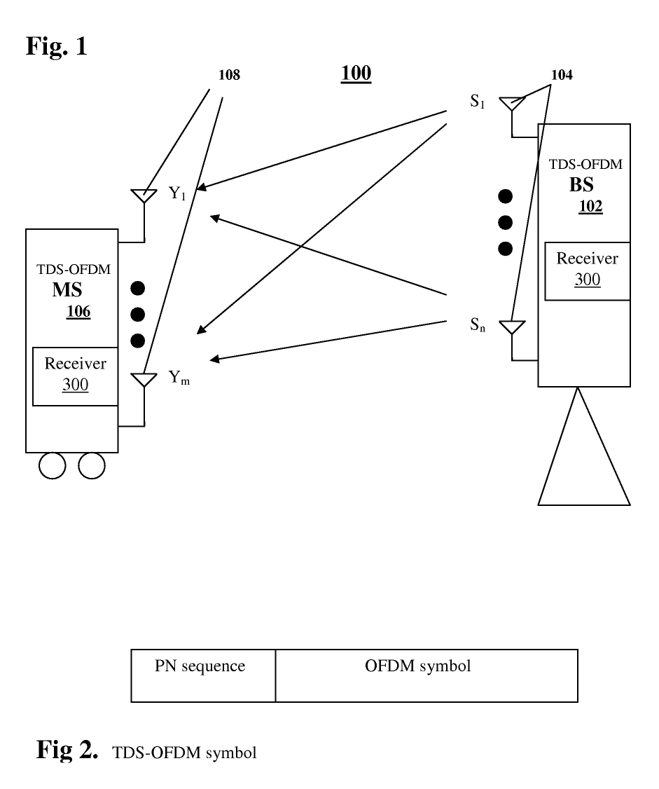

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to variable PN length. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of variable PN length described herein. The non-processor circuits may include, but are not limited to, a radio receiver, a radio transmitter, signal drivers, clock circuits, power source circuits, and user input devices. As such, these functions may be interpreted as steps of a method to perform variable PN length. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Referring specifically to FIG. 2, a packet of transmission or a received packet having PN sequence as guard interval among a plurality of guard intervals (only one shown) is shown. The packet is positioned sequentially within a frame among a multiplicity of packets. As can be appreciated, PNs are disposed between the OFDM symbols. It is noted that the present invention contemplates using the PN sequence disclosed in U.S. Pat. No. 7,072,289 to Yang et al which is hereby incorporated herein by reference.

It is advantageous over other systems in the use of PNs as guard intervals between symbols or data in such systems as TDS-OFDM systems. The advantages include improved channel estimation time, improved synchronization time, and less need to insert more known values such as pilots in what would be used or reserved for data.

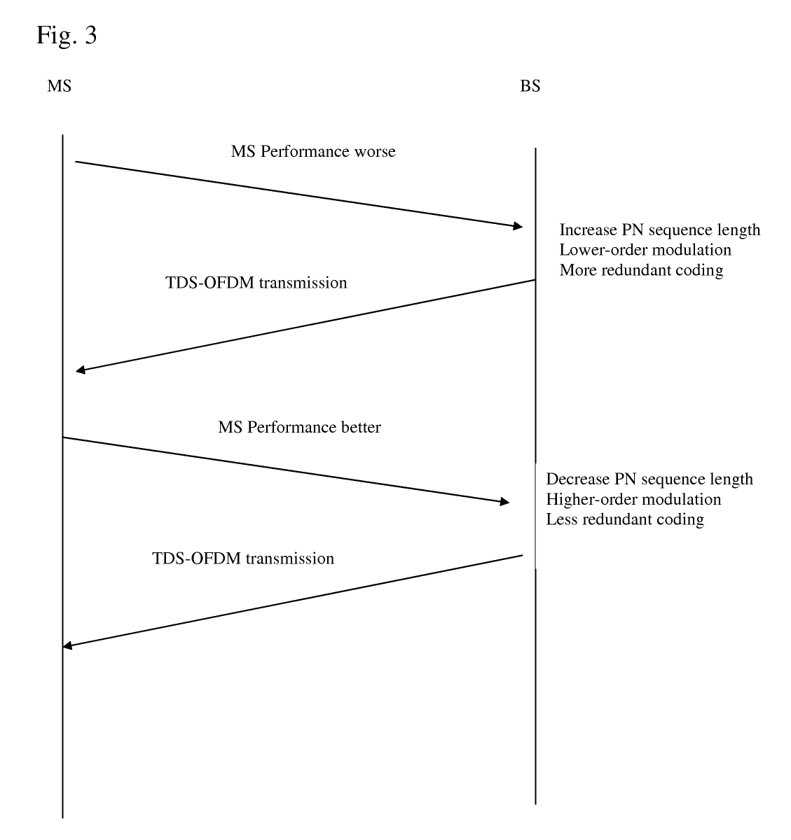

Referring to FIG. 3, an adaptive PN TDS-OFDM (DOWN LINK) system is provided. When MS Performance from MS to BS is known to have worse performance, PN sequence length is increased. Further, lower-order modulation can be performed. More redundant coding can be achieved. Therefore, an improved TDS-OFDM transmission is achieved between BS and MS. On the other hand, When MS Performance form MS to BS is known to have increased or improved performance, PN sequence length is decreased. Further, higher-order modulation can be performed. Less or reduced redundant coding can be achieved. Therefore, an improved TDS-OFDM transmission is achieved between BS and MS.

In an OFDM system, a number of Base stations (BSs) and mobile stations (MS) are disposed to communicate with each other. BS transmits signals S₁, S₂, . . . Sₙ through multiple antennas. At least one antenna use PN sequence. For example signal transmits at the ith antenna Sᵢ uses the format in FIG. 2 employing PN sequence Pᵢ.

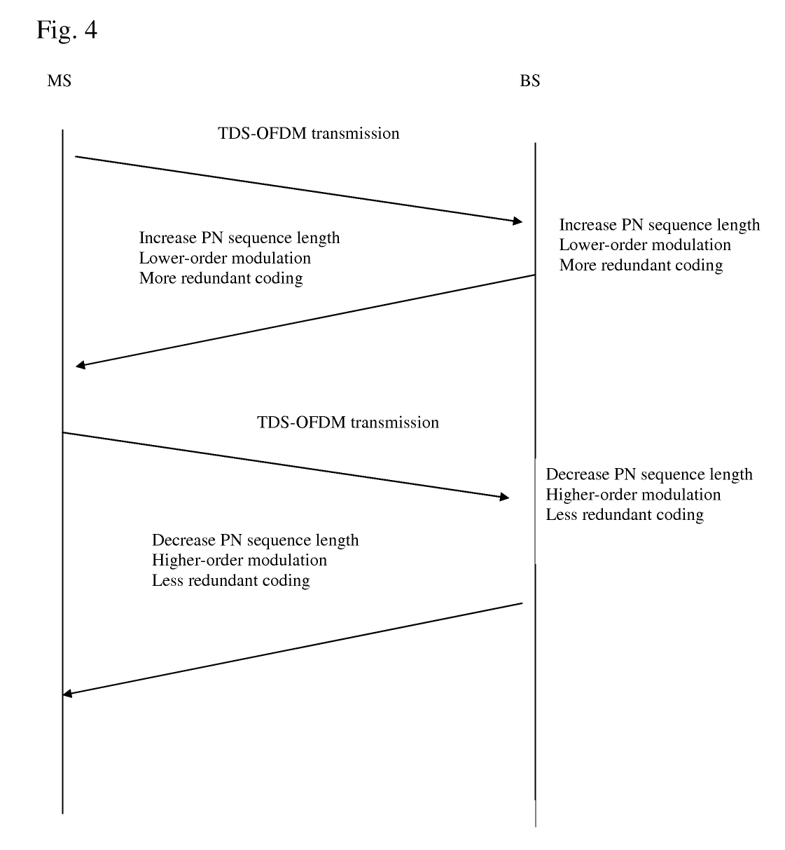

Referring to FIG. 4, an adaptive (UPLINK) PN TDS-OFDM system is shown. Mobile station (MS) receives signals using multiple antennas. Received signal at j-th antenna is Yⱼ. Received signal at j-th antenna Yⱼ receives signals from all transmitted signals. The receiver knows the PN sequences of all transmitted signals. The receiver may feedback demodulation performance to BS. The receiver demodulation performance reflects channel conditions. The BS can adjust the length of PN sequence to data modulation/coding schemes to maintain required performance. If channel condition is worse then before, PN length may increase and may use lower-order modulation and more redundant channel coding methods. If channel becomes better, PN length may decrease and may use high-order modulation and less redundant channel coding methods.

The present invention doesn't need to transmit more power in order to maintain performance, therefore avoiding inter-cell and co-channel interference due to excessive signal power.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In a TDS-OFDM system, a method comprising the step of:
adjusting a PN sequence length, whereby a required performance is maintained.

2. The method of claim 1, wherein the adjusting step comprises increasing the PN sequence length.

3. The method of claim 1, wherein the adjusting step comprises decreasing the PN sequence length.

4. The method of claim 1, wherein the adjusting step comprises keeping the PN sequence length unchanged.

5. The method of claim 1, wherein a data modulation/coding scheme is associated with a PN length.
